(19) United States
(12) Patent Application Publication
(10) Pub. No.: US 2021/0245631 A1
(43) Pub. Date: Aug. 12, 2021

(54) INFORMATION PROCESSING DEVICE, VEHICLE SYSTEM, INFORMATION PROCESSING METHOD, AND PROGRAM

(71) Applicant: TOYOTA JIDOSHA KABUSHIKI KAISHA, Toyota-shi (JP)

(72) Inventors: Mitsuyoshi OHNO, Miyoshi-shi (JP); Daiki KUBO, Toyota-shi (JP); Yosuke NOZAKI, Toyota-shi (JP); Tsukasa NAKANISHI, Nagoya-shi (JP); Hironori AOYAMA, Toyota-shi (JP); Seiji YOGO, Nagoya-shi (JP); Tae SUGIMURA, Miyoshi-shi (JP); Yasuhiro KOBATAKE, Nagoya-shi (JP); Takeshi YAMADA, Anjo-shi (JP); Ryo SATO, Nisshin-shi (JP); Sayaka NINOYU, Toyota-shi (JP)

(73) Assignee: TOYOTA JIDOSHA KABUSHIKI KAISHA, Toyota-shi (JP)

(21) Appl. No.: 17/120,888

(22) Filed: Dec. 14, 2020

(30) Foreign Application Priority Data
Feb. 10, 2020 (JP) 2020-020440

(51) Int. Cl. B60N 2/02; B60N 2/14; B62D 24/00

(52) U.S. Cl. CPC B60N 2/0244; B60N 2002/0268; B62D 24/00; B60N 2/14

(57) ABSTRACT

A control unit is provided that executes: acquiring a first direction that is a direction of the sun as seen from a vehicle that is traveling; acquiring preference data indicating a preference of a user regarding sunlight, the user being moved by the vehicle; and issuing an operation command to an actuator that changes a rotation angle of a seat, in which the user is seated, with respect to the vehicle, based on the first direction and the preference data.

### INCORPORATION BY REFERENCE

The disclosure of Japanese Patent Application No. 2020-020440 filed on Feb. 10, 2020 including the specification, drawings and abstract is incorporated herein by reference in its entirety.

### BACKGROUND

### 1. Technical Field

The present disclosure relates to a technique for providing a mobile service using a vehicle.

### 2. Description of Related Art

Attempts have been made to provide services by dispatching autonomous driving vehicles designed for various applications. For example, Japanese Unexamined Patent Application Publication No. 2019-075047 (JP 2019-075047 A) discloses a device that determines a vehicle to be dispatched based on demands for services and the operating statuses of the vehicles and issues a command to the selected vehicle to move. By dispatching autonomous driving vehicles, it becomes possible to provide various services such as ride sharing services at a lower cost.

For the users who ride in a vehicle to travel, there is a desire to avoid direct sunlight or to be actively exposed to direct sunlight. In relation to this, Japanese Unexamined Patent Application Publication No. 2017-024652 (JP 2017-024652 A) discloses a vehicle in which the orientation and arrangement of seats can be dynamically changed.

### SUMMARY

By changing the orientation and arrangement of the seats, it is possible to satisfy a desire regarding exposure to direct sunlight, for example, temporarily avoiding the direct sunlight. However, the direction of the sun with respect to the seat may change depending on the traveling direction of the vehicle.

The present disclosure has been made in consideration of the above issues, and an object of the present disclosure is to satisfy a desire regarding exposure of an occupant of a vehicle to direct sunlight.

A first aspect of the present disclosure provides an information processing device including a control unit. The control unit executes: acquiring a first direction that is a direction of the sun as seen from a vehicle that is traveling; acquiring preference data indicating a preference of a user regarding sunlight, the user being moved by the vehicle; and issuing an operation command to an actuator that changes a rotation angle of a seat, in which the user is seated, with respect to the vehicle, based on the first direction and the preference data.

A second aspect of the present disclosure provides a vehicle system including a vehicle and an information processing device. Specifically, the vehicle includes an actuator that changes a rotation angle of a seat, in which a user is seated, with respect to the vehicle. The information processing device has a control unit that executes: acquiring a first direction that is a direction of the sun as seen from the vehicle; acquiring preference data indicating a preference of the user regarding sunlight; and issuing an operation command to the actuator based on the first direction and the preference data.

A third aspect of the present disclosure provides an information processing method including: a step of acquiring a first direction that is a direction of the sun as seen from a vehicle that is traveling; a step of acquiring preference data indicating a preference of a user regarding sunlight, the user being moved by the vehicle; and a step of issuing an operation command to an actuator that changes a rotation angle of a seat, in which the user is seated, with respect to the vehicle, based on the first direction and the preference data.

Further, another aspect provides a program for causing a computer to execute the above information processing method, or a computer-readable storage medium in which the program is non-transitorily stored.

According to the present disclosure, it is possible to satisfy a desire of an occupant of a vehicle regarding exposure to direct sunlight.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic diagram of a vehicle system according to a first embodiment;

FIG. 2 is a diagram showing an overall configuration of a vehicle system according to the first embodiment;

FIG. 3 is a diagram showing an arrangement of seat devices;

FIG. 4 shows an example of azimuth data stored in a storage unit;

FIG. 5 shows an example of input/output data to and from a control unit;

FIG. 6A is a diagram illustrating an angle of the sun;

FIG. 6B is a diagram illustrating the angle of the sun;

FIG. 7 is a flowchart of a process executed by an in-vehicle device;

FIG. 8 is a diagram showing an overall configuration of a vehicle system according to a second embodiment;

FIG. 9A is an external view of a vehicle according to the second embodiment; and

FIG. 9B is the external view of the vehicle according to the second embodiment.

### DETAILED DESCRIPTION OF EMBODIMENTS

An information processing device according to the present embodiment is a device for controlling sunlight to a user riding in an autonomous driving vehicle in a system that transports the user by the autonomous driving vehicle.

The vehicle in the present embodiment is, for example, a moving body provided with a plurality of wheels and a drive power. The vehicle may be a vehicle that performs autonomous driving under the control of a computer mounted on the vehicle. With such a vehicle, it is possible to provide a mobile service such as ride sharing.

When a vehicle having a large opening is operated, direct sunlight may be a problem for occupants. Although it is conceivable to provide a curtain on the window, it may be difficult to provide an independent curtain for each seat when a large number of people ride in the vehicle.

Further, in the vehicle, various services may be provided while moving, but direct sunlight may be a problem depending on the type of service. For example, when the vehicle cabin functions as an office, a problem may occur that the screen of the computer becomes difficult to see due to direct sunlight. Further, when providing services such as makeup and hair setting in the vehicle, the sunlight reflected in the mirror may hinder the service provision.

In order to solve these problems, an information processing device according to the embodiment includes a control unit that executes: acquiring a first direction that is a direction of the sun as seen from a vehicle that is traveling; acquiring preference data indicating a preference of a user regarding sunlight, the user being moved by the vehicle; and issuing an operation command to an actuator that changes a rotation angle of a seat, in which the user is seated, with respect to the vehicle, based on the first direction and the preference data.

The first direction is a direction of the sun with respect to the vehicle, and can be represented by an azimuth of 0 degree to 360 degrees, for example. The preference data indicates the preference of the user regarding the sunlight. The preference data indicates an individual preference, for example, “I want to avoid direct sunlight” or “I want to be exposed to sunlight”. The control unit issues the operation command to the actuator based on the first direction and the preference data. The actuator is a mechanism for changing the rotation angle of the seat, in which the user is seated, with respect to the vehicle. The control unit operates the actuator so that the direction of the sun seen from the user can be set to any direction that matches the preference of the user.

The vehicle may be provided with a body that is a cabin portion, or may be a chassis that is not provided with a cabin portion and is able to be coupled to the cabin portion to travel. Further, the actuator may rotate the seat directly or indirectly. For example, when the vehicle is a chassis alone, the rotation angle of the seat with respect to the vehicle may be changed by rotating the body as a whole mounted thereon.

Further, the control unit may characterized by further acquiring a traveling direction of the vehicle and calculating the first direction based on the traveling direction. With such a configuration, even when the traveling direction of the vehicle changes, the direction of the sun seen from the user remains constant. The traveling direction of the vehicle may be determined based on actual measurement (for example, azimuth information acquired by the geomagnetic sensor) or may be determined based on a plan (for example, planned route of the vehicle).

Further, a storage unit that stores azimuth data in which an azimuth angle of the sun by time is defined may be further provided, and the control unit may be characterized by calculating the first direction based on the azimuth data and the traveling direction. The azimuth data can be, for example, data for obtaining the azimuth angle of the sun (for example, an angle expressed in the range of 0 degree to 360 degrees with true north as 0 degree) from the date and time. This makes it possible to calculate the exact position of the sun.

The control unit may be characterized by calculating the rotation angle and issuing the operation command periodically such that a second direction that is a direction of the sun seen from the user seated in the seat is maintained at a direction specified by the preference data. This makes it possible to satisfy the user's desire, for example, “I always want the sun behind me”.

Further, the actuator may be characterized by being included in a base of the seat and rotating the seat about a direction of gravity to change the rotation angle of the seat with respect to the vehicle. For example, by disposing the actuator between the seat surface and the floor, the seat can be configured to be rotatable as a whole.

In addition, the vehicle may be characterized by being configured to be coupled to a vehicle cabin unit provided with the seat and rotating the vehicle cabin unit coupled to the vehicle about the direction of gravity to change the rotation angle of the seat with respect to the vehicle. When the vehicle is a chassis alone and can be coupled to the vehicle cabin unit that is the body, the vehicle cabin unit may be rotated with respect to the vehicle. With such a configuration, the rotation angle of the seat with respect to the vehicle can be collectively changed.

Further, the control unit may be characterized by further acquiring external data for determining whether the vehicle is exposed to direct sunlight, and stopping issuing the operation command when the control unit determines that the vehicle is not exposed to direct sunlight. The external data can be, for example, data indicating weather. This is because when the weather is cloudy or rainy, direct sunlight cannot be a problem.

Hereinafter, embodiments of the present disclosure will be described with reference to the drawings. The configurations of the following embodiments are illustrative, and the present disclosure is not limited to the configurations of the embodiments.

### First Embodiment

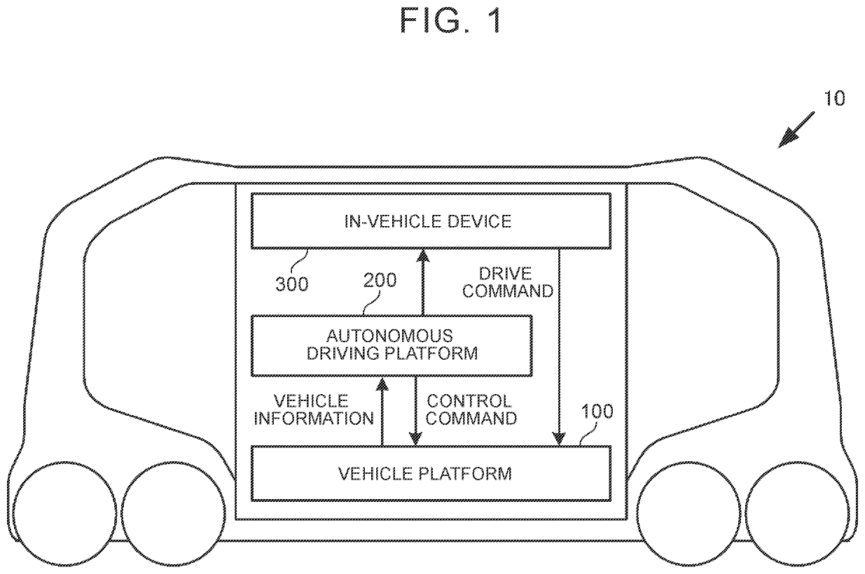

An outline of the vehicle system according to a first embodiment will be described with reference to FIG. 1. A vehicle 10 according to the present embodiment includes a vehicle platform 100 that autonomously travels based on a given command, an autonomous driving platform 200 that is an autonomous driving device, and an in-vehicle device 300 that controls the orientation (rotation angle) of a seat.

The vehicle platform 100 is a platform including a computer that controls traveling of the vehicle (for example, an engine electronic control unit (ECU) or the like). The vehicle platform 100 operates based on a control command and generates vehicle information. The control command and the vehicle information are transmitted and received with a controller area network (CAN) frame flowing through an in-vehicle network. The autonomous driving platform 200 is a platform including a computer that performs autonomous driving control of the vehicle (for example, an autonomous driving ECU). The autonomous driving platform 200 senses surroundings of the vehicle and generates a control command for the vehicle platform 100 based on the sensing result. The in-vehicle device 300 is a device that controls the orientation (rotation angle) of the seat of the vehicle 10 based on the positional relationship between the vehicle 10 and the sun.

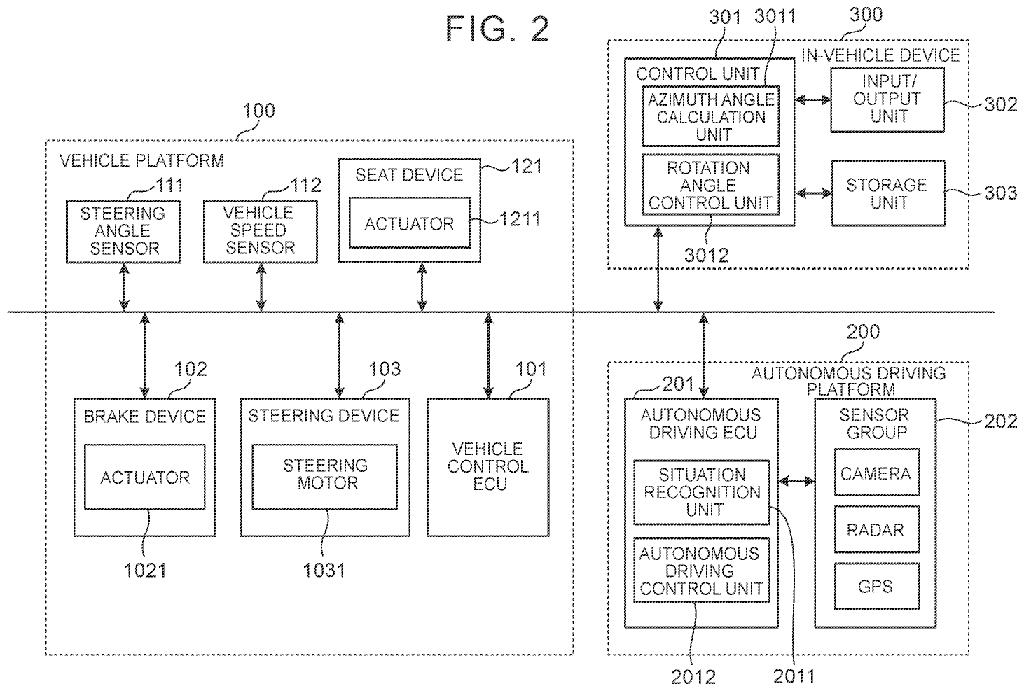

Next, components of the system will be described in detail. FIG. 2 is a block diagram schematically showing an example of the configuration of the vehicle system shown in FIG. 1. The vehicle system includes the vehicle platform 100, the autonomous driving platform 200, and the in-vehicle device 300, which are connected by a bus so as to be able to communicate with each other.

The vehicle platform 100 includes a vehicle control ECU 101, a brake device 102, a steering device 103, a steering angle sensor 111, and a vehicle speed sensor 112. In this example, a vehicle having an engine is taken as an example, but the vehicle may be an electric vehicle. In this case, the engine ECU can be replaced with an ECU that manages the drive power of the vehicle. The vehicle platform 100 may be equipped with ECUs and sensors other than those shown.

The vehicle control ECU 101 is a computer that controls components of the vehicle (engine system components, powertrain system components, brake system components, electric system components, body system components, etc.). The vehicle control ECU 101 may be a group of computers. The vehicle control ECU 101 controls the engine speed by performing fuel injection control, for example. The vehicle control ECU 101 can control the engine speed based on, for example, a control command (for example, a command that specifies a throttle valve opening) generated by operation of an occupant (accelerator pedal operation or the like).

When the vehicle 10 is an electric vehicle, the vehicle control ECU 101 can control the rotation speed of the motor by controlling drive voltage, current, driving frequency, and the like. Also in this case, similarly to the vehicle with an internal combustion engine, the rotation speed of the motor can be controlled based on the control command generated by the operation of the occupant. Further, the regenerative current can be controlled based on the depression force of the brake pedal or a control command indicating the degree of regenerative braking. When the vehicle 10 is a hybrid vehicle, both control for the engine and control for the motor may be performed.

In addition, the vehicle control ECU 101 can control the braking force of the mechanical brake by controlling an actuator 1021 included in the brake device 102 described later. The vehicle control ECU 101 controls a brake hydraulic pressure by driving an actuator 1021 based on, for example, a control command (for example, a command indicating the depression force of the brake pedal) generated by operation of the occupant (brake pedal operation or the like).

Further, the vehicle control ECU 101 can control the steering angle or the angle of the steered wheels (steering angle) by controlling a steering motor 1031 included in the steering device 103 described later. The vehicle control ECU 101 controls the steering angle of the vehicle by driving the steering motor 1031 based on, for example, a control command (for example, a command indicating a steering angle) generated by operation of the occupant (steering operation or the like).

The control command may be generated inside the vehicle platform 100 based on the operation of the occupant, or may be generated outside the vehicle platform 100 (for example, by the autonomous driving platform 200).

The brake device 102 is a mechanical brake system included in the vehicle. The brake device 102 includes an interface (brake pedal or the like), the actuator 1021, a hydraulic system, a brake cylinder, and the like. The actuator 1021 is means for controlling the hydraulic pressure in the brake system. The actuator 1021 that receives a command from the vehicle control ECU 101 controls the brake hydraulic pressure, so that the braking force of the mechanical brake can be secured.

The steering device 103 is a steering system included in the vehicle. The steering device 103 includes an interface (a steering wheel or the like), a steering motor 1031, a gear box, a steering column, and the like. The steering motor 1031 is means for assisting the steering operation. By driving the steering motor 1031 that receives a command from the vehicle control ECU 101, the force required for steering operation can be reduced. Further, by driving the steering motor 1031, it is possible to automate the steering operation that does not require the operation of the occupant.

The steering angle sensor 111 is a sensor that detects a steering angle obtained by the steering operation. The detection value obtained by the steering angle sensor 111 is transmitted to the vehicle control ECU 101 as needed. In the present embodiment, the steering angle is a numerical value that directly represents the vehicle wheel turning angle, but a value that indirectly represents the vehicle wheel turning angle may be used. The vehicle speed sensor 112 is a sensor that detects the speed of the vehicle. The detection value obtained by the vehicle speed sensor 112 is transmitted to the vehicle control ECU 101 as needed.

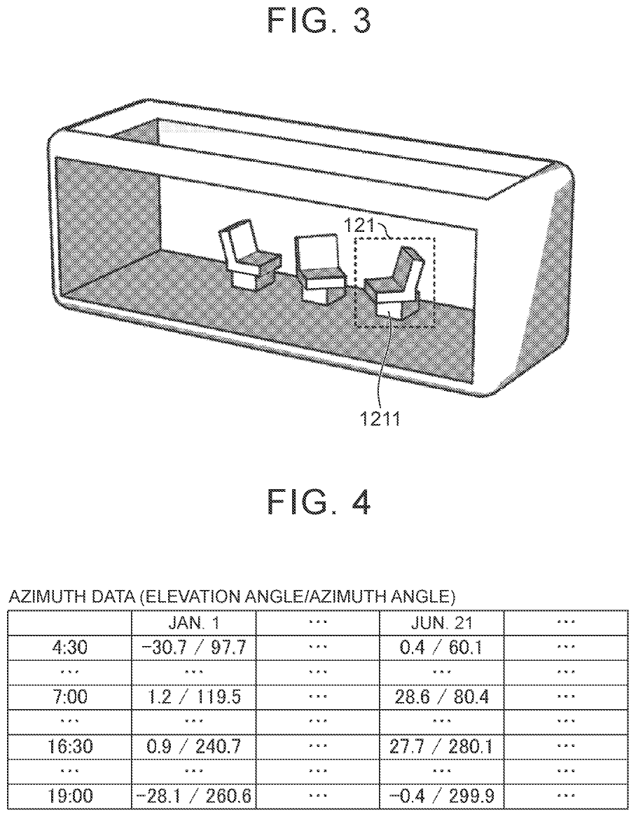

A seat device 121 includes a seat in which an occupant of the vehicle is seated. The seat device 121 has an actuator 1211, and can rotate the seat at a desired angle. FIG. 3 is a perspective view of a vehicle cabin of a vehicle (the wall and the ceiling are partially omitted). As illustrated, the seat device 121 can rotate the surface on which the occupant is seated by 360 degrees about the direction of gravity.

Next, the autonomous driving platform 200 will be described. The autonomous driving platform 200 is a device that senses the surroundings of the vehicle, generates a plan regarding traveling based on the sensing result, and issues a control command to the vehicle platform 100 according to the plan. The autonomous driving platform 200 may be developed by a manufacturer or a vendor different from those of the vehicle platform 100. The autonomous driving platform 200 includes an autonomous driving ECU 201 and a sensor group 202.

The autonomous driving ECU 201 is a computer that makes a determination regarding autonomous driving based on data obtained from the sensor group 202 described later and communicates with the vehicle platform 100 so as to control the vehicle. The autonomous driving ECU 201 is composed of, for example, a central processing unit (CPU). The autonomous driving ECU 201 has two functional modules, that is, a situation recognition unit 2011 and an autonomous driving control unit 2012. Each functional module may be implemented by the CPU executing a program stored in storage means such as a read only memory (ROM).

The situation recognition unit 2011 detects the environment around the vehicle based on the data acquired by the sensors included in the sensor group 202 described later. Objects to be detected include, for example, the number and the positions of lanes, the number and the positions of other vehicles around the vehicle, the number and the positions of obstacles around the vehicle (pedestrians, bicycles, structures, buildings, etc.), the structure of the road, road signs, and the like, but not limited to these. Any object may be detected as long as it is necessary for autonomous traveling. The data regarding the environment (hereinafter, environmental data) detected by the situation recognition unit 2011 is transmitted to the autonomous driving control unit 2012 described below.

The autonomous driving control unit 2012 uses the environmental data generated by the situation recognition unit 2011 to control the traveling of the vehicle. For example, the autonomous driving control unit 2012 generates the traveling locus of the vehicle based on the environmental data, and determines the acceleration/deceleration and the steering angle of the vehicle so that the vehicle travels along the traveling locus. The information determined by the autonomous driving control unit 2012 is transmitted to the vehicle platform 100 (vehicle control ECU 101). A known method can be adopted as a method for causing the vehicle to travel autonomously.

In the present embodiment, the autonomous driving control unit 2012 generates a command regarding acceleration/deceleration of the vehicle (acceleration/deceleration command) and a command regarding a steering angle of the vehicle (steering angle command), and transmits the commands to the vehicle platform 100. Further, the autonomous driving control unit 2012 transmits information indicating the traveling direction of the vehicle to the in-vehicle device 300. This will be described later.

The sensor group 202 is means for performing sensing the surroundings of the vehicle, and typically includes a monocular camera, a stereo camera, a radar, a light detection and ranging (LIDAR), a laser scanner, and the like. The sensor group 202 may include means for acquiring the current position of the vehicle (Global Positioning System (GPS) module or the like), as well as means for sensing the surroundings of the vehicle. The data acquired by the sensors included in the sensor group 202 is transmitted to the autonomous driving ECU 201 (situation recognition unit 2011) as needed.

The in-vehicle device 300 determines the positional relationship between the user seated in the seat and the sun based on the direction of the sun and the traveling direction of the vehicle. Further, the in-vehicle device 300 issues a drive command to the actuator 1211 to rotate the seat in which the user is seated so that the direction of the sun seen from the user falls within a range that satisfies the preference of the user.

The in-vehicle device 300 may be constituted by a general-purpose computer. That is, the in-vehicle device 300 can be configured as a computer having a processor such as a CPU or a graphics processing unit (GPU), a main storage device such as a random access memory (RAM) or a ROM, an auxiliary storage device such as an erasable programmable read only memory (EPROM), a hard disk drive, and a removable medium. Note that the removable medium may be, for example, a universal serial bus (USB) memory or a disc recording medium such as a compact disc (CD) or a digital versatile disc (DVD). An operating system (OS), various programs, various tables, and the like are stored in the auxiliary storage device. The programs stored in the auxiliary storage device are loaded into the work area of the main storage device and executed, and through this execution, various components are controlled so that various functions can be implemented that match the predetermined purpose, which will be described later. However, some or all of the functions may be implemented by a hardware circuit such as an application specific integrated circuit (ASIC) or a field programmable gate array (FPGA).

The control unit 301 is an arithmetic device that governs the control performed by the in-vehicle device 300. The control unit 301 can be realized by an arithmetic processing device such as a CPU. The control unit 301 includes two functional modules, that is, an azimuth angle calculation unit 3011 and a rotation angle control unit 3012. Each functional module may be implemented by execution of a stored program by the CPU.

The azimuth angle calculation unit 3011 acquires an azimuth angle of the sun (azimuth angle based on true north) based on data (azimuth data including the azimuth angle of the sun) stored in the storage unit 303 described later. Further, the azimuth angle calculation unit 3011 calculates the azimuth angle of the sun seen from the vehicle 10 based on the data (the traveling direction of the vehicle 10) acquired from the autonomous driving platform 200. In the following description, the azimuth angle of the sun with respect to the vehicle 10 (that is, the azimuth angle of the sun seen from the vehicle 10, which is also referred to as a first direction) is referred to as a sun angle.

Based on the sun angle calculated by the azimuth angle calculation unit 3011 and the preference of the occupant in the vehicle 10 regarding the sunlight, the rotation angle control unit 3012 calculates such rotation angle of the seat that the sunlight matches the preference. Then, based on the rotation angle, the rotation angle control unit 3012 generates a command for driving the actuator 1211 included in the seat device 121 and transmits the command. The rotation angle of the seat is represented, for example, by an angle in the range of 0 degree to 360 degrees with the traveling direction of the vehicle 10 being 0 degree.

An input/output unit 302 is an interface for inputting/outputting information. The input/output unit 302 includes, for example, a display device and a touch panel. The input/output unit 302 may include a keyboard, a camera, a speaker, a touch screen, and the like.

The storage unit 303 includes a main storage device and an auxiliary storage device. The main storage device is a memory in which a program executed by the control unit 301 and data used by the control program are expanded. The auxiliary storage device is a device that stores a program executed by the control unit 301 and data (for example, azimuth data) used by the control program.

FIG. 4 is an example of the azimuth data stored in the storage unit 303. The azimuth data is data for calculating the azimuth angle of the sun using the time and date as keys, and can be a table as shown in the drawing, for example. In the illustrated example, the azimuth angle of the sun is defined for each time and date. Since the azimuth angle of the sun varies depending on the place (latitude and longitude), the azimuth data may be held for each place. Further, the azimuth data may be a mathematical expression.

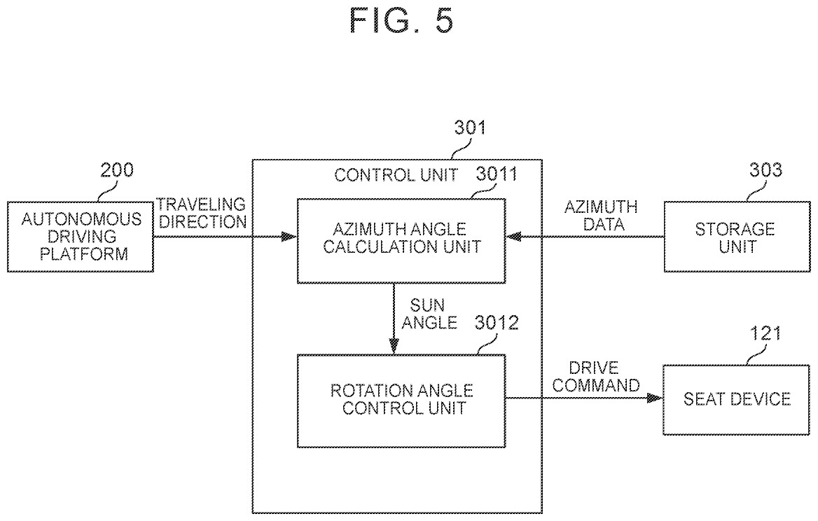

FIG. 5 is a diagram illustrating data input and output to and from the control unit 301. The azimuth angle calculation unit 3011 acquires data indicating the current traveling direction of the vehicle 10 from the autonomous driving platform 200 (autonomous driving control unit 2012). The traveling direction of the vehicle may be acquired, for example, using a geomagnetic sensor or the like, or may be calculated based on the planned traveling route and the current position. The traveling direction of the vehicle is represented by, for example, the azimuth angle based on true north.

Furthermore, the azimuth angle calculation unit 3011 acquires the azimuth data from the storage unit 303, and calculates the current azimuth angle of the sun based on the point (latitude and longitude), the time, and the date where the vehicle 10 is traveling.

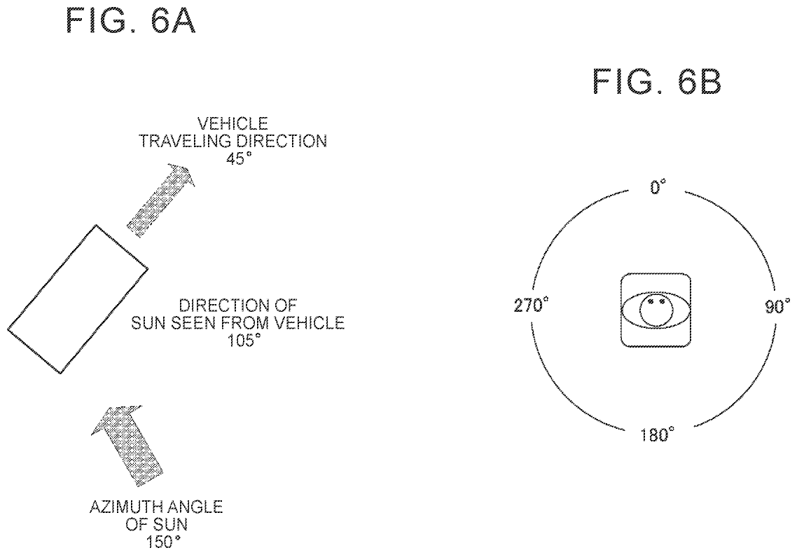

Subsequently, the azimuth angle calculation unit 3011 calculates the sun angle based on the calculated azimuth angle of the sun and the traveling direction of the vehicle 10. As a result, the azimuth angle of the sun in the coordinate system with the vehicle being as a reference is calculated. For example, as shown in FIG. 6A, when the azimuth angle of the sun based on true north is 150 degrees and the traveling direction (azimuth angle) of the vehicle based on true north is 45 degrees, the azimuth angle of the sun with respect to the vehicle (as seen from the vehicle) is 105 degrees. The calculated value is transmitted to the rotation angle control unit 3012.

The rotation angle control unit 3012 determines the rotation angle of the seat with respect to the vehicle 10 based on the sun angle and the preference of the user seated in the corresponding seat. Examples of the user's preference include the following. FIG. 6B is a diagram illustrating the azimuth angle of the sun with respect to the user.
The user wants the sun to be positioned behind him/her (at 90 degrees or more and less than 270 degrees)
The user wants the sun to be positioned in front of him/her (270 degrees or more and less than 90 degrees)
The user wants the sun to be positioned to the left of him/her (0 degree or more and less than 180 degrees)
The user wants the sun to be positioned to the right of him/her (180 degrees or more and less than 360 degrees)
The user wants to specify in detail the angle at which the sun is positioned For example, when the sun angle is 105 degrees and the user wants the sun to be positioned behind him/her (180 degrees), the rotation angle of the seat may be set to −75 degrees.

The data indicating the user's preference (preference data) can be acquired before the user gets on the vehicle 10. For example, in the case where the vehicle 10 is a ride sharing vehicle, the preference data may be transmitted from the user terminal to the management server when the user reserves a ride, and the management server may transfer the preference data to the in-vehicle device 300. At this time, an identifier of the user or an identifier of the seat in which the user is to be seated may be transmitted together with the preference data. Further, in the case where the seat is not specified, data for associating the user with the seat may be acquired via the input/output unit 302 when the user gets on the vehicle 10.

The rotation angle control unit 3012 transmits a drive command specifying the rotation angle of the seat to the seat device 121 (actuator 1211). By periodically executing the processes described above, the angle of the sun with respect to the user can be always maintained at a desired value.

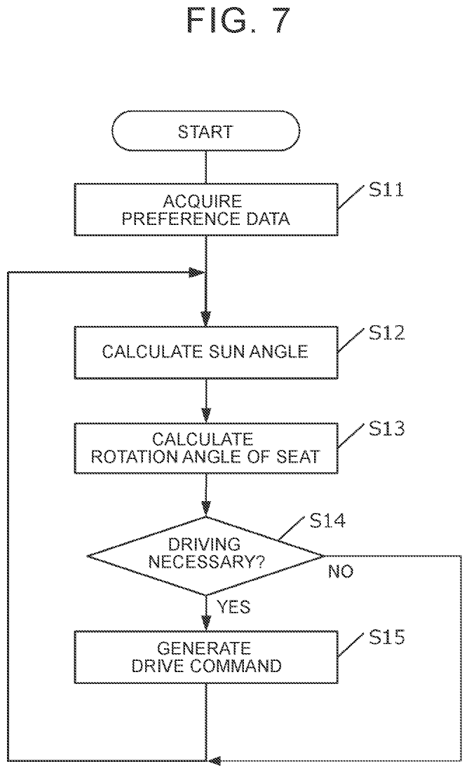

FIG. 7 is a flowchart of a process executed by the in-vehicle device 300 (control unit 301). The process is executed at the timing when the vehicle 10 starts traveling. When there are a plurality of users in the vehicle 10, the steps described below may be executed for each user.

First, in step S11, the rotation angle control unit 3012 acquires preference data corresponding to a user. The preference data may be acquired from a server device that manages the operation of the vehicle 10, or may be acquired from a terminal owned by the user. Alternatively, the preference data may be acquired from an interface device (input/output unit 302) provided in the vehicle cabin.

In step S12, the azimuth angle calculation unit 3011 acquires the traveling direction of the vehicle 10 and the azimuth data corresponding to the place and the date and time where the vehicle 10 travels to calculate the sun angle. Next, in step S13, the rotation angle control unit 3012 calculates a required rotation angle of the seat based on the sun angle and the preference data.

In step S14, the rotation angle control unit 3012 determines whether the rotation angle of the seat needs to be changed. For example, in the following cases, the rotation angle control unit 3012 determines that it is not necessary to change the rotation angle.

(1) When the calculated rotation angle is not outside the range indicated by the preference data Thereby, the frequency of rotating the seat can be suppressed.

(2) When the elevation angle of the sun indicated by the azimuth data is smaller than a predetermined value

(3) Other than the above, when it can be assumed that the vehicle 10 is not exposed to direct sunlight

This is because, for example, when the altitude of the sun is sufficiently low or when the weather is other than sunny, direct sunlight does not pose a problem. When an affirmative determination is made in step S14, the process proceeds to step S15. When a negative determination is made in step S14, it is determined that it is not necessary to rotate the seat, and the process returns to step S12. Note that the control unit 301 may be configured to be able to acquire additional external data for making the determination in (3). The external data can be, for example, data indicating weather, but may be other data as long as the determination on whether the user is exposed to direct sunlight can be determined.

In step S15, the rotation angle control unit 3012 generates and transmits a drive command for the actuator 1211. As a result, the seat in which the user is seated rotates so as to match the preference data.

As described above, the in-vehicle device 300 according to the first embodiment changes the rotation angle of the seat in which the user is seated so as to satisfy the user's preference regarding the sunlight. With this configuration, it is possible to provide a comfortable moving environment for the user. Further, by repeating the process shown in FIG. 7, the angle of the sun with respect to the user can be maintained at a value desired by the user.

### Second Embodiment

In the first embodiment, the seat in which the user is seated is rotated by the actuator 1211 included in the seat device 121. In contrast, in a second embodiment, the chassis and the body (vehicle cabin unit) are separable and the body itself is rotated.

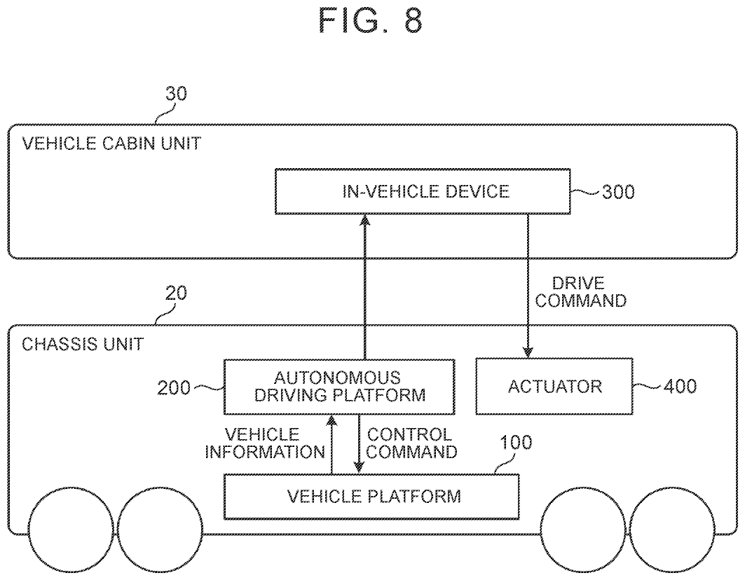

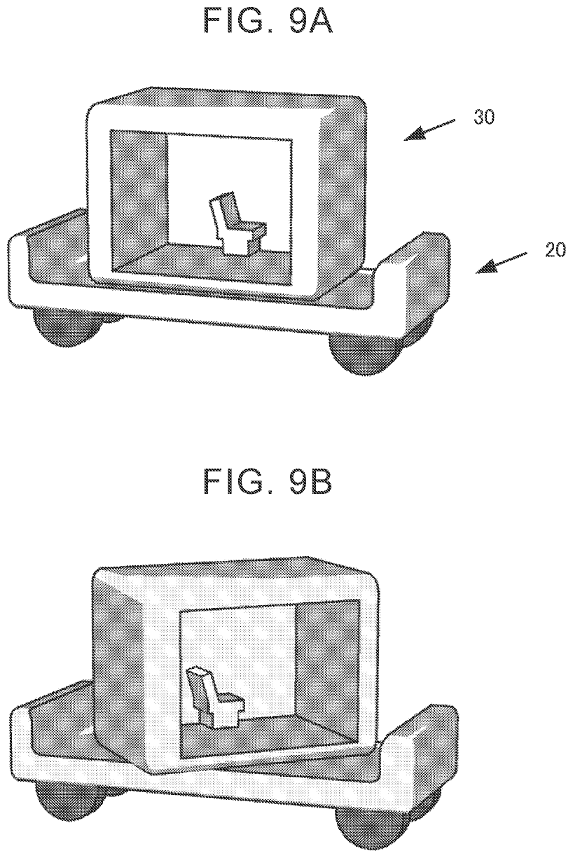

FIG. 8 is a schematic diagram of a vehicle system according to the second embodiment. The vehicle according to the second embodiment includes a chassis unit 20 that is a unit for traveling and a vehicle cabin unit 30 that is a unit having a cabin portion. FIG. 9A is a diagram showing an appearance of a vehicle according to the second embodiment (part of the wall is omitted).

The vehicle cabin unit 30 is a unit that a user rides in and has predetermined facilities. Examples of the predetermined facilities include a seat, a table, a lighting device, and an air conditioning system, but other facilities may be provided as long as they are provided in the vehicle cabin.

The chassis unit 20 and the vehicle cabin unit 30 can be coupled and separated in accordance with the application. For example, by replacing the chassis units 20 with a chassis unit 20 having a different capacity, a vehicle for a desired number of passengers can be composed. In addition, the application of the vehicle can be changed by replacing the chassis unit 20 with a chassis unit 20 for a different application. The coupling and the separation of the chassis unit 20 and the vehicle cabin unit 30 may be controlled by an external server device, or may be controlled by the chassis unit 20 or the vehicle cabin unit 30. Further, the coupling and the separation may be performed by a predetermined device (lift or the like).

In the first embodiment, the seat device 121 is provided with the actuator 1211. However, in the second embodiment, instead of the actuator 1211, the chassis unit 20 is provided with an actuator 400 for rotating the vehicle cabin unit 30. FIG. 9B is a diagram showing the vehicle cabin unit 30 rotated by the actuator 400.

In the second embodiment, the rotation angle control unit 3012 issues a drive command to the actuator 400. Other processes executed by the in-vehicle device 300 are the same as those in the first embodiment. According to the second embodiment, the entire vehicle cabin is rotated, rather than the respective seats, so that a sense of discomfort given to the users in the vehicle cabin can be suppressed.

### Modification

The above-described embodiment is merely an example, and the present disclosure may be appropriately modified and implemented without departing from the scope thereof. For example, the processes and means described in the present disclosure can be freely combined and implemented as long as no technical contradiction occurs.

Further, the processes described as being executed by one device may be shared and executed by a plurality of devices. Alternatively, the processes described as being executed by different devices may be executed by one device. In the computer system, it is possible to flexibly change the hardware configuration (server configuration) for realizing each function.

The present disclosure can also be implemented by supplying a computer with a computer program that implements the functions described in the above embodiments, and causing one or more processors of the computer to read and execute the program. Such a computer program may be provided to the computer by a non-transitory computer-readable storage medium connectable to the system bus of the computer, or may be provided to the computer via a network. The non-transitory computer-readable storage medium is, for example, a disk of any type such as a magnetic disk (floppy (registered trademark) disk, hard disk drive (HDD), etc.), The non-transitory computer-readable storage medium is, for example, a disc of any type such as a magnetic disc (floppy (registered trademark) disc, hard disk drive (HDD), etc.), an optical disc (compact disc (CD)-ROM, digital versatile disc (DVD), Blu-ray disc, etc.), a read only memory (ROM), a random access memory (RAM), an erasable programmable read only memory (EPROM), an electrically erasable programmable read only memory (EEPROM), a magnetic card, a flash memory, an optical card, and any type of medium suitable for storing electronic commands. an optical disc (compact disc (CD)-ROM, digital versatile disc (DVD), Blu-ray disc, etc.), a read only memory (ROM), a random access memory (RAM), an erasable programmable read only memory (EPROM), an electrically erasable programmable read only memory (EEPROM), a magnetic card, a flash memory, an optical card, and any type of medium suitable for storing electronic commands.

What is claimed is:

1. An information processing device, comprising a control unit that executes:
acquiring a first direction that is a direction of the sun as seen from a vehicle that is traveling;
acquiring preference data indicating a preference of a user regarding sunlight, the user being moved by the vehicle; and
issuing an operation command to an actuator that changes a rotation angle of a seat, in which the user is seated, with respect to the vehicle, based on the first direction and the preference data.

2. The information processing device according to claim 1, wherein the control unit further acquires a traveling direction of the vehicle, and calculates the first direction based on the traveling direction.

3. The information processing device according to claim 2, further comprising a storage unit that stores azimuth data in which an azimuth angle of the sun by time is defined, wherein the control unit calculates the first direction based on the azimuth data and the traveling direction.

4. The information processing device according to claim 1, wherein the control unit calculates the rotation angle and issues the operation command periodically such that a second direction that is a direction of the sun seen from the user seated in the seat is maintained at a direction specified by the preference data.

5. The information processing device according to claim 1, wherein the actuator is included in a base of the seat, and rotates the seat about a direction of gravity to change the rotation angle of the seat with respect to the vehicle.

6. The information processing device according to claim 1, wherein:
the vehicle is configured to be coupled to a vehicle cabin unit provided with the seat; and
the actuator rotates the vehicle cabin unit coupled to the vehicle about a direction of gravity to change the rotation angle of the seat with respect to the vehicle.

7. The information processing device according to claim 1, wherein:
the control unit further acquires external data for determining whether the vehicle is exposed to direct sunlight; and
when determining that the vehicle is not exposed to the direct sunlight, the control unit stops issuing the operation command.

8. A vehicle system comprising: a vehicle; and an information processing device, wherein:
the vehicle includes an actuator that changes a rotation angle of a seat, in which a user is seated, with respect to the vehicle; and
the information processing device has a control unit that executes
acquiring a first direction that is a direction of the sun as seen from the vehicle,
acquiring preference data indicating a preference of the user regarding sunlight, and
issuing an operation command to the actuator based on the first direction and the preference data.

9. The vehicle system according to claim 8, wherein:
the vehicle notifies the information processing device of a traveling direction; and
the control unit calculates the first direction based on the traveling direction.

10. The vehicle system according to claim 9, wherein:
the information processing device further includes a storage unit that stores azimuth data in which an azimuth angle of the sun by time is defined; and
the control unit calculates the first direction based on the azimuth data and the traveling direction.

11. The vehicle system according to claim 8, wherein the control unit calculates the rotation angle and issues the operation command periodically such that a second direction that is a direction of the sun seen from the user seated in the seat is maintained at a direction specified by the preference data.

12. The vehicle system according to claim 8, wherein the actuator is included in a base of the seat, and rotates the seat about a direction of gravity to change the rotation angle of the seat with respect to the vehicle.

13. The vehicle system according to claim 8, wherein:
the vehicle is configured to be coupled to a vehicle cabin unit provided with the seat; and
the actuator rotates the vehicle cabin unit coupled to the vehicle about a direction of gravity to change the rotation angle of the seat with respect to the vehicle.

14. The vehicle system according to claim 8, wherein:
the control unit further acquires external data for determining whether the vehicle is exposed to direct sunlight; and
when determining that the vehicle is not exposed to the direct sunlight, the control unit stops issuing the operation command.

15. An information processing method comprising:
a step of acquiring a first direction that is a direction of the sun as seen from a vehicle that is traveling;
a step of acquiring preference data indicating a preference of a user regarding sunlight, the user being moved by the vehicle; and
a step of issuing an operation command to an actuator that changes a rotation angle of a seat, in which the user is seated, with respect to the vehicle, based on the first direction and the preference data.

16. The information processing method according to claim 15, further comprising a step of acquiring a traveling direction of the vehicle, wherein the first direction is calculated based on the traveling direction.

17. The information processing method according to claim 16, further comprising a step of acquiring azimuth data in which an azimuth angle of the sun by time is defined, wherein the first direction is calculated based on the azimuth data and the traveling direction.

18. The information processing method according to claim 15, wherein calculation of the rotation angle and issuance of the operation command are performed periodically such that a second direction that is a direction of the sun seen from the user seated in the seat is maintained at a direction specified by the preference data.

19. The information processing method according to claim 15, further comprising a step of acquiring external data for determining whether the vehicle is exposed to direct sunlight, wherein when a determination is made that the vehicle is not exposed to the direct sunlight, the issuance of the operation command is stopped.

20. A program for causing a computer to execute the information processing method according to claim 15.
